(19) United States
(12) Patent Application Publication
(10) Pub. No.: US 2003/0191554 A1
(43) Pub. Date: Oct. 9, 2003

(54) Method and system for the generation of a computer model

(76) Inventors: Raymond Macdonald Russell, Birmingham (GB); Stuart Alexander Watson, Hertfordshire (GB)

Correspondence Address: MICHAEL BEST & FRIEDRICH, LLP, 100 E WISCONSIN AVENUE, MILWAUKEE, WI, 53202, US

(21) Appl. No.: 10/174,524

(22) Filed: Jun. 18, 2002

(30) Foreign Application Priority Data
Apr. 9, 2002 (GB) GB 0208088.5

(51) Int. Cl. G06F 19/00

(52) U.S. Cl. 700/187

(57) ABSTRACT

A method of producing a control data set capable of controlling a machine tool comprising the steps of:

(i) providing processing means capable of generating data and causing said processing means to generate a parametric surface indicative of the shape of an object;

(ii) causing said processing means to generate a mesh indicative of a shape of a relief, said relief comprising height contours and said mesh having at least one edge;

(iii) causing said processing means to perform one of the following: project said mesh onto said surface; wrap said mesh on to said surface; intersect said mesh with said surface, so as to preserve said height contours of said relief relative to one another; and

(iv) causing said processing means to determine a trim boundary of the surface, said trim boundary having at least one edge, by performing one of the following: projecting said mesh into said surface; wrapping said mesh onto said surface; or intersecting said mesh with said surface, using said processing means such that said at least one edge of said mesh and said at least one edge of said trim boundary are contiguous.

This invention relates to a method and system for the generation of a computer model. More particularly but not exclusively it relates to a method and system for the generation of a Computer Aided Design (CAD) model.

The computer modelling of ‘real world’ objects (often used for the generation of control commands for machine tools) typically employs one of two techniques—either surface or solid modelling.

Surface modelling represents an object by modelling its outer ‘skin’, and allows pieces of this skin to the modelled separately—with no restriction on the pieces forming a closed, ‘watertight’ boundary.

Solid modelling extends surface modelling by constraining the user to work at all times with a definition of a closed, watertight boundary.

Both types of model can be used to generate machine toolpaths, display a representation of the model on a workstation monitor, produce CAD drawings, produce models from rapid prototyping machines (3D printers) and the like.

Both surface and solid modellers usually represent the skin of the model with parametric surfaces. However, for complex surfaces, with a high degree of localised detail, parametric surfaces do not form a convenient way to model the detail because the mathematical parameters become too detailed. Such complex ‘reliefs’ are often represented by polygonised surfaces or by voxel solids.

This technique represents the surface or solid by a large number of small tessellating elements. This ‘relief modelling’ technique allows complex shapes to be modelled, but does not provide the convenience of having mathematical models of the surface (because there are too many elements to allow easy editing).

The model provided by the relief modelling technique does not have a mathematical representation of the surface and cannot therefore simply be combined with the model of an object. So-called hybrid packages are available that do provide the two techniques, but these in reality provide two distinct models that co-exist. When the two models are arranged to coincide it appears as if a single model has been provided. However, should either of the models be resized (as is often performed using modelling packages) then the two models may well become separated and need further work to bring the two together once more. For example the relief model may disappear inside the solid model, or float above its surface.

It is an aim of the present invention to ameliorate at least some of the problems of the prior art.

According to a first aspect of the present invention there is provided a method of generating a computer model comprising the steps of:

(i) generating a parametric surface indicative of the shape of an object upon a processing means;

(ii) generating a mesh indicative of a shape of a relief using the processing means;

(iii) projecting or wrapping the mesh onto the surface or intersecting the mesh with the surface using the processing means so as to preserve the height contours of the relief relative to one another; and

(iv) determining a trim boundary of the surface by projecting or wrapping the mesh onto the surface, or intersecting the mesh with the surface, using the processing means such that an edge of the mesh and an edge of the trim boundary are contiguous.

It will be appreciated that the term mesh as used herein relates to a set of points, nodes or vertices coupled with information detailing how said points, nodes or vertices can be connected to form a set of polygons.

An advantage of such a method is that it allows the production of a ‘watertight’ model of an object suitable for the production of rapid prototypes using rapid prototyping machines (3D printers). A further advantage of such a method is that it produces a model where alterations, for example scaling, to the model are reflected in both the surface and the relief since the relief is combined with the surface. Such an arrangement allows the development of objects that otherwise have not been possible using computer aided design techniques. For example, the sole of a sport shoe may be modelled. This has previously not been practical.

The selective use of parametric surfaces and polygonal meshes to represent distinct faces of a solid object has benefits, for example parametric surfaces are smaller to store than meshes and can represent smooth surfaces accurately. Facets can only approximate to a curved surface due to their planar nature. Polygonal meshes are excellent at representing complex textured details. Thus, each type of data has its own merits.

Preferably the method comprises a step (v) in which a portion of the parametric surface internal of the boundary determined in step (iv) is trimmed away. Such an arrangement is convenient because it ensures that the parametric surface and the mesh do not interfere with one another. If the surface defined by the mesh is always above the parametric surface then it may be possible to leave the portion undeleted. However, if the mesh extends below the parametric surface then the surface would interfere with the mesh and in such circumstances it is advantageous to delete a portion of the parametric surface.

Preferably the method may include recording the execution of the projection of the mesh onto the surface in the form of an event, typically this applies to a solid model. In a solid model, each event that changes the model is normally referred to as a feature.

The method may include keeping a record of features of the model. The method may include combining the surface model and the mesh such that a feature executed on the surface affects the mesh, where appropriate. For example said surface and said mesh may be combined such that a change executed to said surface causes said processing means to re-calculate said mesh such that said at least one edge of said mesh and said trim boundary remain contiguous. Such an arrangement is convenient because a model can be manipulated and both the mesh and the parametric surface are manipulated together.

The method may include re-wrapping the mesh onto the surface following alteration of a feature. This will typically occur as part of the normal feature definition.

The method may include displaying the record of the features, graphically, upon a screen of a user's workstation. The method may include allowing a user to select a feature to be altered from the record displayed graphically upon the screen of his/her workstation. The method may include manipulating a graphical representation of an object comprising the surface and the mesh by a user upon a screen of a workstation. This has the advantage of bringing the flexibility of a solid model to a solid/relief hybrid in cascading changes from a prior feature into the current model.

Projection or wrapping of the mesh onto a surface may be thought of as the inverse of the process used when an image is texture mapped by a graphics card onto a surface.

The method may include using a texture mapped image of the surface in texture space to guide the mapping from points on the mesh to the surface. The method may include generating a set of images of points of the mesh in which each pixel in the image is arranged to have a colour assigned thereto, said colour representing a surface parameter, typically an S or T parameter, of the point on the surface to where a given point will be wrapped.

The method may include projecting intersecting or wrapping the mesh onto the surface in a common space, typically a common texture space. This may include approximating a point of coincidence between a node of the mesh and a node of the surface. The approximation of the point of coincidence may include zoning the surface into polygons (preferably triangles) and may further include interpolating the location of a node of the mesh within a given polygon (triangle) using, typically eight bit, coordinates that are usually associated with surface parameters (S, T) that define the surface. The co-ordinates are typically referenced to the vertices of the given polygon (triangle). The method may include assigning the location of the node of the mesh a ordinate in one dimensional texture space, typically a twenty-four bit value. Alternatively, the method may include assigning the location of the node of the mesh a co-ordinate in two dimensional texture space. This allows two quantities to be interpolated simultaneously. Thus, an approximation to the point of intersection of the mesh with the surface is made initially with a more accurate determination of the point of intersection being made subsequently.

This is advantageous as the accurate determination of the point of intersection is essential to the wrapping of the mesh upon the surface in order to prevent distortion of the mesh when wrapped onto the surface. Such an accurate determination is very slow to execute in software. The technique employed in this method mimics the texture mapping used by a graphics card of a computer and thus the graphics card can execute the accurate determination in hardware, decreasing the computational time involved in executing the addition of a relief to a surface in a computer model.

The method may include composing a mesh of polygons to represent the relief. Typically the polygons are triangles because they are guaranteed to be planar and always tessellate.

The method may include generating polygons on the surface. The method may further include matching contiguous edges of respective polygons of the surface and mesh. This has the advantage of generating a watertight model that is suitable for rapid prototyping machines.

The method may include previewing the projection or wrapping of the polygonal mesh by using an image of the mesh, texture mapped onto the surface. Such a method is convenient because is allows a user to readily view what surface relief is about to be provided.

Step (iii) of the method may include wrapping the mesh onto the surface. Such wrapping of the mesh allows it to be fitted to the parametric surface. The method may also include intersecting the mesh with the surface.

Step (iii) of the method may include varying the position and/or orientation of the mesh on the surface, for example by way of scaling, rotating or translating of the mesh. Such varying of the position and/or orientation of the mesh allows the pattern within the mesh and/or the dimensions of the mesh to be varied allowing for user manipulation thereof.

The method may include taking at least one node and generally each node or substantially each node of the mesh and mapping said node onto the surface, typically this is achieved using the information that the texture mapping process used to preview the projection or wrapping of the mesh onto the surface.

The method may include rendering the relief onto the surface using a graphics card of a workstation. The method may include using a texture wrapped bitmap of a relief to guide the wrapping of the polygonal surface mesh.

The method may include generating either a negative or positive relief, relative to the surface, in step (ii). Having the ability to provide both a negative and a positive relief may provide a greater degree of flexibility in the objects that can be modelled.

The method may include providing at least a portion of the processing means in the form of a video card or other computer peripheral. This has the advantage that specialist processing routines, such as texture mapping, can be used that use the video cards inherent structure to yield enhanced performance over prior art systems without having to increase the power or speed of a central processing unit (CPU) of a workstation employing the method. Thus speed of the method is increased on the same performance hardware.

The method may include generating the mesh of the relief from a height field model. A height field model is a two dimensional grid of three-dimensional pixels each of which has an independent height value in the third dimension.

The method may include generating the mesh of the relief from a voxel model. A voxel model is defined as a three dimensional grid of three-dimensional pixels each of which typically has the same width, depth and height.

The method may include converting the parametric surface to a plurality of planar polygons. Such a method is especially convenient when the resulting model is to be used to drive a rapid prototyping machine (3D printer).

The method may include matching the respective lengths of contiguous edges of respective polygons of the surface and the mesh. This step is advantageous because it ensures that the surface is completely covered by the polygons and there are no voids in the surface, which is especially advantageous when a 3D printer is to be driven by the data. Preferably, the surface model is arranged to generate data to control a machine tool.

The machine tool may be a Computer Numerically Controlled (CNC) machine tool, or may be a rapid prototyping machine (3D printer).

The method may include providing a reliefs in the form of three dimensional clip art. This allows a user to drop reliefs onto a model rapidly and easily without the need for complex modelling steps.

The method may include generating a control data set suitable for controlling a rapid prototyping machine. Alternatively or additionally, the method may include generating a control data set suitable for controlling a computer numerically controlled (CNC) machine tool.

According to a second aspect of the invention there is provided a system for generating a computer model, said system comprising a parametric surface generator arranged to generate a parametric surface, a mesh generator arranged to generate a mesh representing a relief, boundary generating means arranged to generate a boundary at least a portion of which lies within the parametric surface generated by the parametric surface generator, and a projector means arranged to project the mesh onto the boundary.

The system may also comprise a trimming means arranged to trim away a portion of the parametric surface defined by the boundary. Such an arrangement is convenient because it helps to ensure that the parametric surface and the relief do not conflict with one another.

Preferably, the system further comprises a coupling means arranged to couple the parametric surface and the mesh. Such an arrangement is convenient because it allows a unitary model to be provided.

Any one or more of the following may be provided by a processor: parametric surface generator; mesh generator; boundary generating means; projecting means; trimming means; coupling means.

The processor may include a graphics processor capable of performing texture mapping as a hardware instruction.

According to a third aspect of the present invention there is provided a machine tool, the machine tool being arranged to produce a workpiece, including a surface relief, in response to commands from a processor, the commands being generated in response to a computer model of the workpiece, the model being generated in accordance with the first aspect of the present invention.

The machine tool may be a CNC tool, typically a milling tool. The machine tool may be a rapid prototyping machine.

According to a fourth aspect of the present invention there is provided a method of controlling a machine tool comprising the steps of:

(i) generating a control data set representative of a computer model of a workpiece, including a surface relief, the computer model being generated in accordance with the first aspect of the present invention;

(ii) generating a set of commands to drive the machine tool, according to the model, at a processor;

(iii) imparting relative motion between a tool head of the machine tool and a substance arranged to form the workpiece.

The machine tool may be a CNC tool, typically a milling tool. The machine tool may be a rapid prototyping machine.

According to a fifth aspect of the present invention there is provided processing circuitry arranged to generate a computer model of a workpiece in accordance with the first aspect of the present invention.

Preferably the circuitry comprises a video card, typically of a PC. The circuitry may include an output in the form of either a screen or a printer.

According to a sixth aspect of the invention there is provided a method of generating a computer model which provides means for processing data, capable of generating, of processing, of transforming and of storing said data and further comprising the steps of:

(i) causing said processing means to generate a parametric surface indicative of the shape of an object;

(ii) causing said processing means to generate a mesh indicative of the shape of a relief, said mesh having an outside contour and said relief having associated height contours;

(iii) causing said processing means to generate a plurality of polygons approximating to said mesh;

(iv) causing said processing means to generate a plurality of polygons approximating to said parametric surface;

(v) causing said processing means to execute at least one of the following so as to preserve said height contours of said relief relative to one another: projecting said mesh onto said surface; wrapping said mesh onto said surface; and intersecting said mesh with said surface;

(vi) causing said processing means to determine a trim boundary of said surface, said trim boundary bounding a void within said surface, such that said outside contour of said mesh and said trim boundary are contiguous, by said execution of said processing means causing at least one of the following: projecting said mesh onto said surface; wrapping said mesh onto said surface; and intersecting said mesh with said surface; and

(vii) causing said processing means to ensure that said polygons approximating to said mesh and said polygons approximating to said parametric surface including matching contiguous edges.

According to a seventh aspect of the present invention there is provided a computer readable memory device encoded with a data structure for producing a computer model comprising a first entry and a second entry; the first entry containing a parameter relating to a trim boundary of a parametric surface; a second entry containing a parameter relating to an outer edge of a polygonal mesh; the first and second parameters having substantially the same values.

Preferably the parameter contains a flag detailing that the trim boundary corresponds to another boundary, typically the outer edge of the mesh.

Desirably there is provided a third entry relating to a feature of the model, typically the model is a solid model. More desirably, the third entry contains details of the way in which the mesh is projected or wrapped onto, or intersected with, the surface, such that the mesh can be re-projected, re-wrapped or re-intersected should the model be changed.

According to an eighth aspect of the present invention there is provided a machine readable medium readable by a machine and encoding a program of instructions which when operated on the machine causes the machine to execute the method of any one of the first, fourth or sixth aspects of the present invention.

According to a ninth aspect of the present invention there is provided a machine readable medium readable by a machine and encoding a program of instructions which when operated on the machine causes the machine to operate as a machine tool in accordance with the second aspect of the present invention.

According to a tenth aspect of the present invention there is provided an object machined using a control data set generated from a model produced in accordance with the method of the first aspect of the present invention. The object may be a sole for a shoe, typically a sports shoe. Alternatively the object may be packaging, typically a bottle. The object may be tableware, for example a bowl, cup, saucer or plate.

Currently soles must be manually modelled and the sole sent from the supplier to the customer for approval, possibly a distance of thousands of miles. This clearly introduces delays in the production process, particularly if the supplier-customer cycle is repeated a number of times. Therefore, the present invention will provide advantageous for the manufacture of shoes and may well save time and money for the manufacturers.

According to an eleventh aspect of the present invention there is provided a method of producing a control data set for the control of a machine tool comprising the steps of:

(i) generating a parametric surface indicative of the shape of an object upon a processing means;

(ii) generating a mesh indicative of a shape of a relief using the processing means;

(iii) projecting or wrapping the mesh onto the surface or intersecting the mesh with the surface using the processing means so as to preserve the height contours of the relief relative to one another; and

(iv) determining a trim boundary of the surface by projecting or wrapping the mesh onto the surface, or intersecting the mesh with the surface, using the processing means such that an edge of the mesh and an edge of the trim boundary are contiguous.

The machine tool may be a CNC tool, typically a milling tool. The machine tool may be a rapid prototyping machine.

The invention will now be described, by way of example only, with reference to the accompanying drawings, in which:

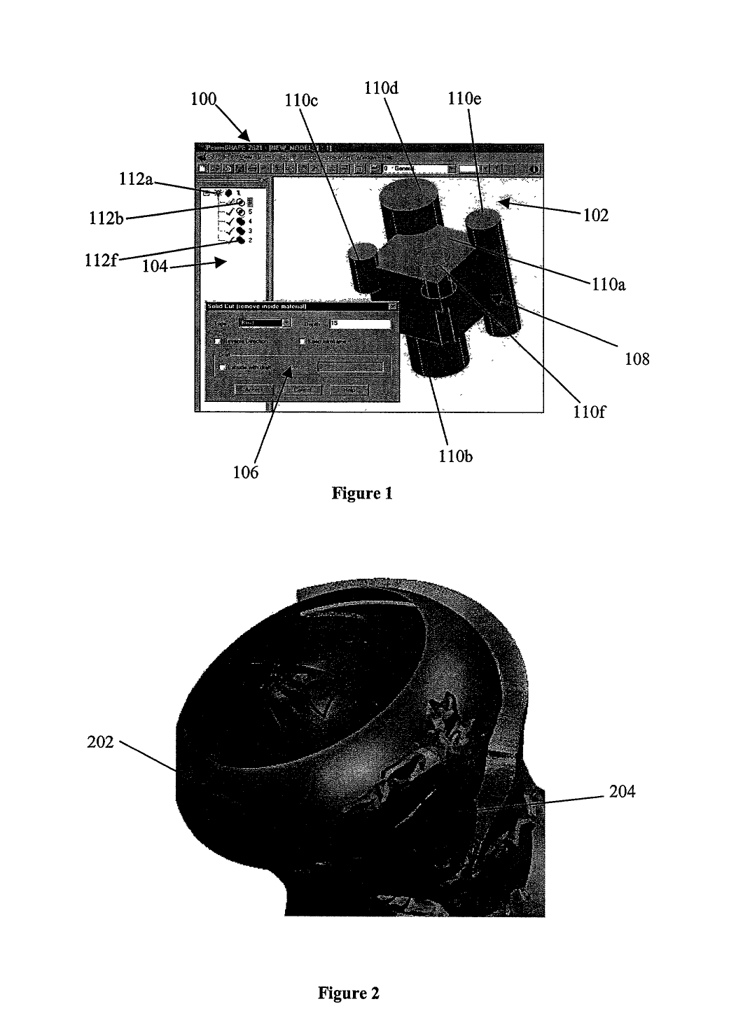

FIG. 1 is a representation of a screen dump of a prior art solid modelling package;

FIG. 2 is a representation of a prior art arrangement of a parametric surface and a polygonal mesh superposed upon the surface, showing that the surface is untrimmed and is penetrated by the mesh;

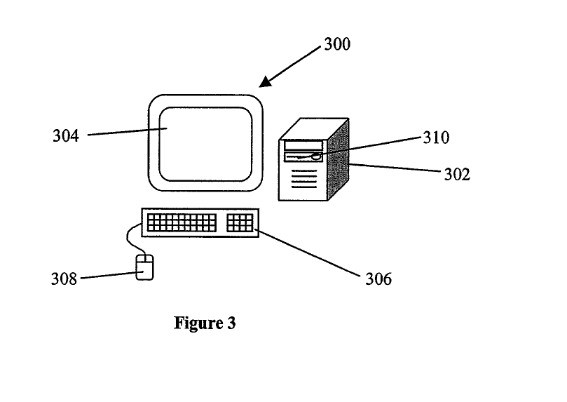

FIG. 3 is a schematic representation of a computer arranged to execute a method according to at least an aspect of the present invention;

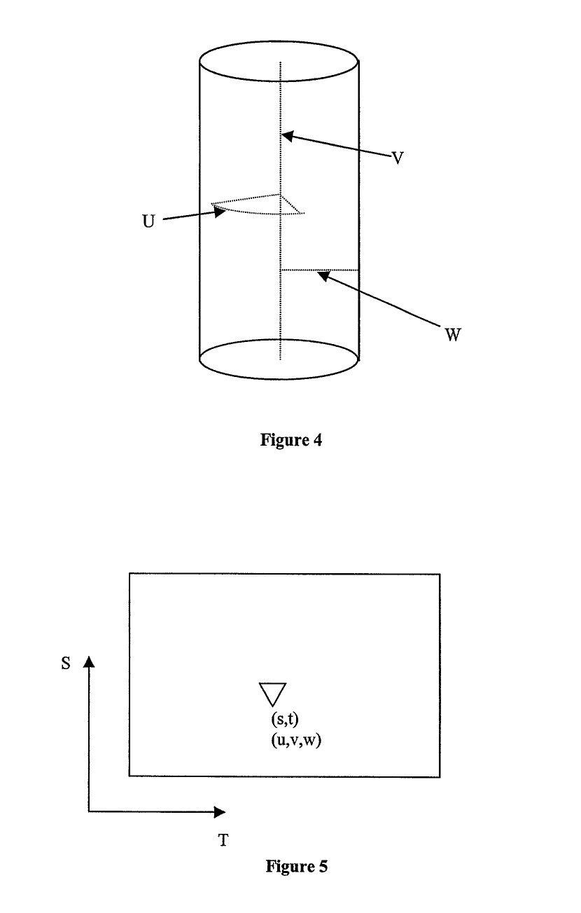

FIG. 4 is a representation of a texture co-ordinate generation cylinder as used in the present invention;

FIG. 5 is a representation of an unwrapped parametric surface, in parameter space;

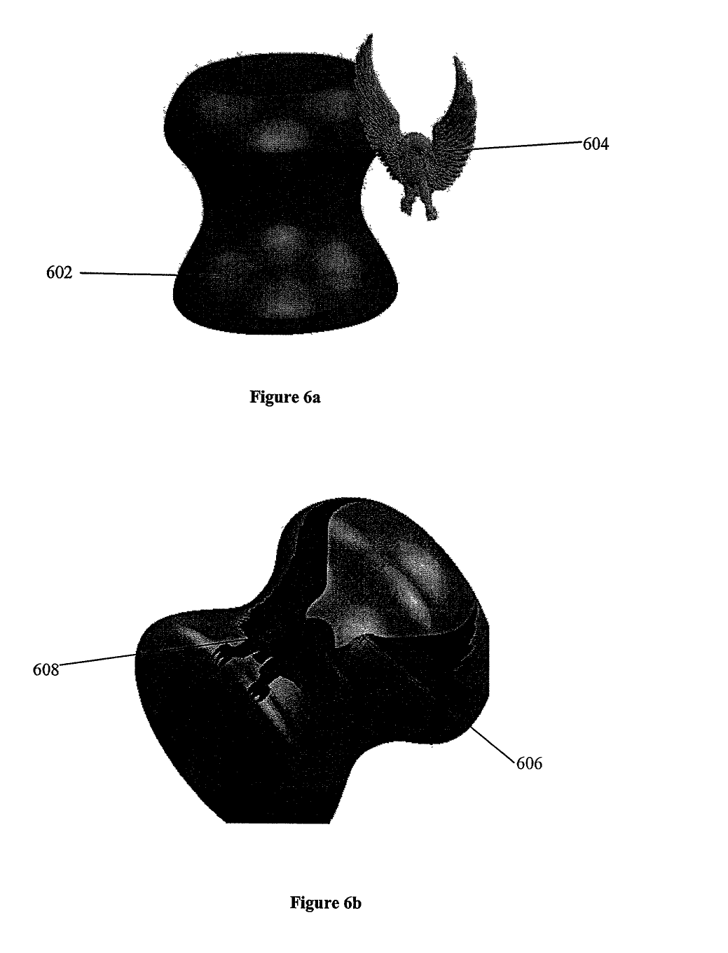

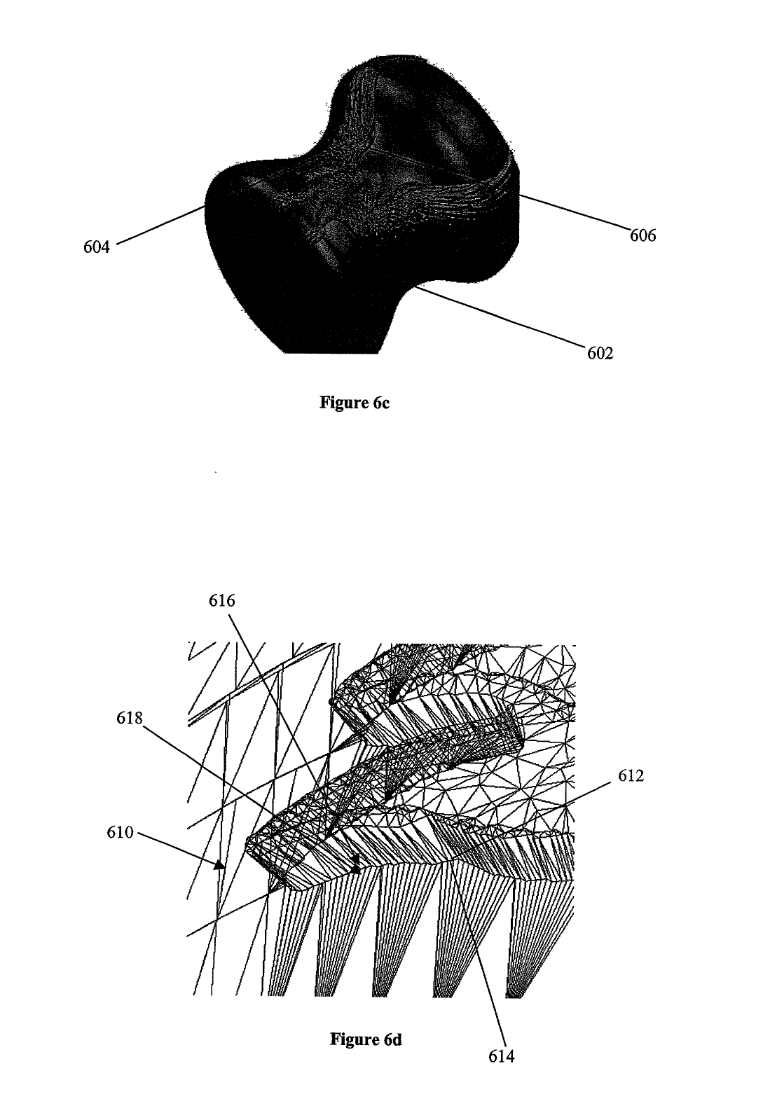

FIG. 6a is a representation of a parametric surface and a polygonal mesh according to at least an aspect of the present invention;

FIG. 6b is a representation of a parametric surface having a void, corresponding to a projection of the polygonal mesh of FIG. 6a, therethrough;

FIG. 6c is a representation of a parametric surface having the polygonal mesh conjoined thereto;

FIG. 6d is a representation of the surface and mesh of FIG. 6aconverted to a triangular faceted mesh, suitable for use in generating a command data set for a rapid prototyping machine;

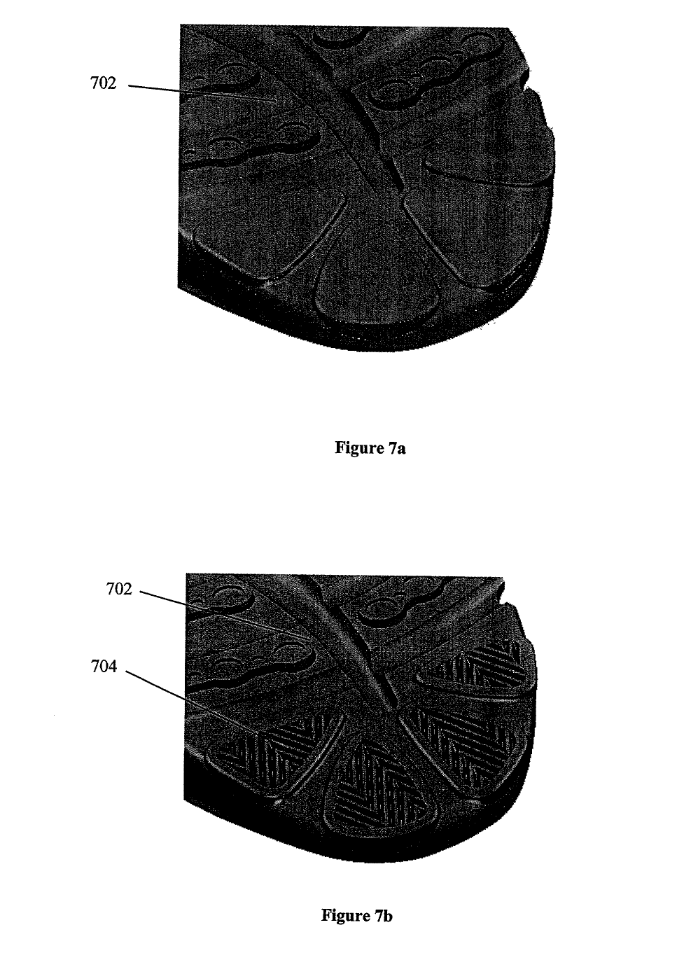

FIGS. 7a and 7b are representations of a sole of a sports shoe generated according to an aspect of the present invention;

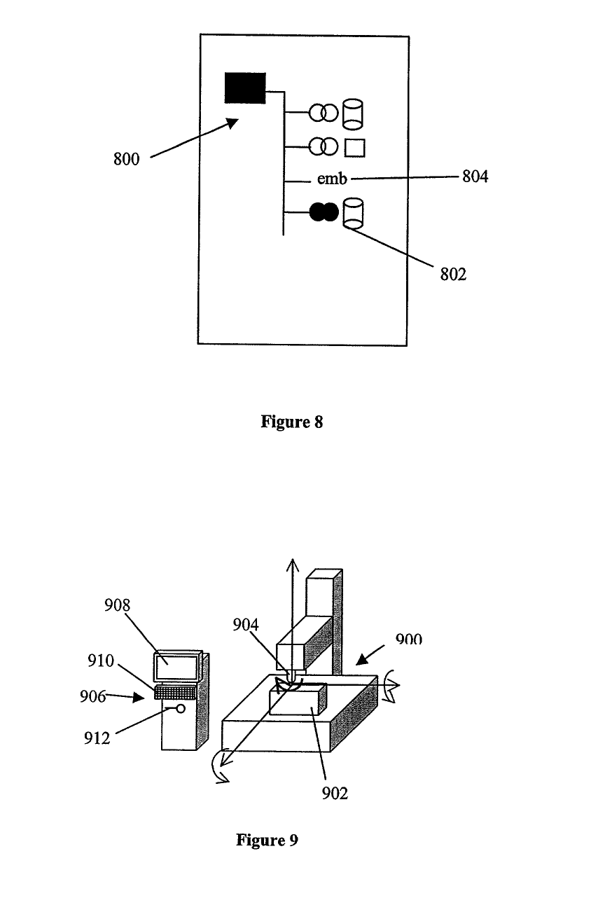

FIG. 8 is a feature tree of a method according to the present invention;

FIG. 9 is a schematic representation of a machine tool arranged to operate under the controls of a data set generated in accordance with at least an aspect of the present invention;

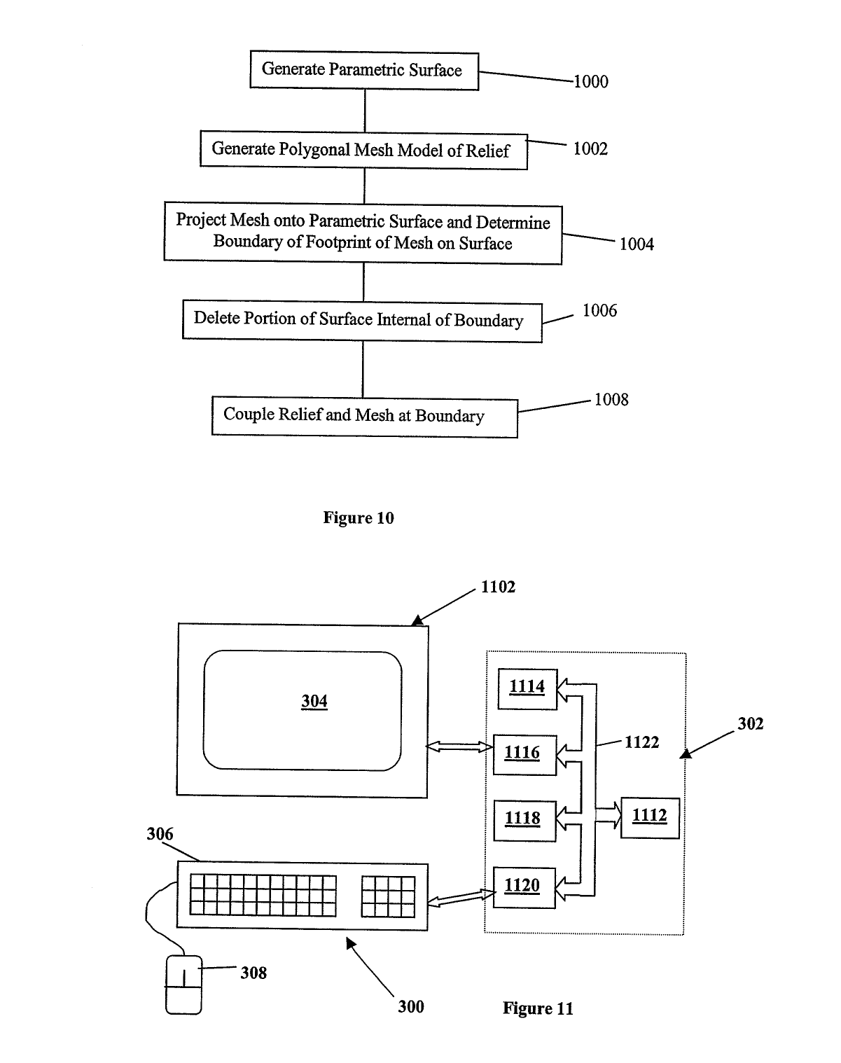

FIG. 10 is a flowchart detailing a method of generation of a control data set for a machine tool according to at least an aspect of the present invention; and

FIG. 11 is a further schematic representation of the computer of FIG. 3.

Solid modelling is well known but for the avoidance of doubt a brief description follows. Objects are built up from building blocks, for example a cuboid or a cylinder. A closed skin is defined over the object. This skin is generally referred to as a ‘Boundary Representation’, the resultant solid being a Boundary Representation, or Brep solid. The surfaces that constitute the Brep are typically stored as parametric surfaces, each surface of the solid is called a face. Some modelling software packages represent the Brep as a mesh of planar facets. The facets are typically planar polygons with triangular facets being most commonly used because of their simplicity. Further building blocks are added to, or subtracted from, the model to yield projections and recesses of the object being modelled, respectively.

Each addition of a building block to, or subtraction of a building block from, the model is termed ‘a feature’ of the model. A history of the sequence of features associated with the model is typically recorded in the form of a feature tree. If the operations are simple Boolean operations of basic primitive shapes the solid is typically referred to as having a Constructive Solid Geometry (CSG). Most solid modelling software packages combine Brep and feature history by storing both the final Brep and a history of all commands used in building the solid. Thus, a user is able to replay the features of the model and alter an earlier feature. The effect of changing an early feature cascades down through the intervening features and is displayed in the current model. This arrangement is easy to use as changes to the model can be made at any feature and the effect of the change upon the final model readily viewed.

Additionally, features are not always easily distinguishable from the model and the modelling package will typically display the feature tree as a user-interface that allows features to be selected and operated on. Each feature in the feature tree will usually have a dialogue box associated with it that allows the feature to be edited.

In a solid modelling package each face (usually a parametric surface) is trimmed to a boundary, or loop, of edges. For example a rectangular face is bounded by four edges. Each edge is represented as a curve, either in two dimensions within a parameter space defined by the surface or in three dimensions. The edge curves can be either parametric curves or polylines (a continuous chain of straight-line segments).

Surface modelling of an object involves the manipulation of sections of surface and the joining of these sections of surface to define a single surface of the solid being modelled. The object being modelled is defined purely by the surface. It is possible to carry out sophisticated edits to the skin of an object in isolation, without the constraint that the surface must be continuous. The manipulation and joining of the sections of surface is highly complex and usually no historical information is retained by surface modelling routines as to how the surface was formed, i.e. there is no feature tree generated, due to this complexity. Thus, the effect of an alteration of a surface does not cascade down the features and is not shown in the final model.

Both surface modelling and solid modelling are suitable for generating instructions for machine tools to machine parts with plain surfaces.

However, where a surface relief, for example a pattern or an artistic relief, is embossed onto the surface the computational complexity involved in using either surface or solid modelling (where the solid is defined as a Brep of parametric surfaces) becomes prohibitive. This is because an enormous number of small variations in height must be used and also irregular shapes are formed, particularly in the case of artistic reliefs.

In response to this, an independent technique of relief modelling has been developed in which the relief is either modelled as a two dimensional height field of three dimensional pixels (each having a different height) or as a three dimensional grid of three dimensional pixels (voxels)—each typically having the same size in x, y and z dimensions. The top surface of such a model can readily be converted into a mesh of polygons (for example triangles). However, there are currently no ready mechanisms for manipulating such data as an integral part of a solid model.

The techniques of surface, or solid, modelling have been combined with relief modelling by allowing the triangulated relief modelling data to be independently positioned in the same space as the surface/solid modelling data. This can result in problems in that if the boundary of, for example, the solid model moves outward the relief surface becomes subsumed by the solid object. This is because the two models are simply in the same space as, and remain independent of, each other. Conversely, if the boundary of, for example, the solid model moves inward the surface relief floats in free space above the surface of the solid modelled object.

A further problem associated with current methods of superposing a surface, or solid, modelled data and relief-modelled data is that they are not ‘watertight’. This means that there may be regions, typically around the edge of the relief, where gaps occur, causing problems when generating instructions for machine tools. This is a particular problem for rapid prototyping machines where large strips of excess material can project from the final object at such gaps in the model.

Referring now to FIG. 1, a solid modelling software package display 100 includes a graphic area 102, a feature tree 104 and a dialogue box 106.

The graphic area 102 includes a computer generated model 108 of an object. The model 108 comprises a plurality of elements 110a-f. Each of the elements 110a-f is selected by a user and either added to or subtracted from the model 108 as it exists at that time. For example, the user selects a cuboid 110a as an initial starting shape, to which the user adds a cylindrical boss 110b. The operation of adding the boss 110b to the cuboid 110a is recorded in the feature tree 104 as an individual feature 112f. The subsequent addition of cylinders 110c-e and the removal of curved sections 110f-g of the cuboid 110a, by removing cylinders placed to be just overlapping the cuboid 110a, are also recorded as individual features 112b-f in the feature tree 104.

The feature tree 104 allows the user to revert to any point in the history of the model 108 by selecting a given feature, for example 112b, from the feature tree 104. An additional feature can be introduced into the model at any point in the feature tree 104. Cross-linking the effect of an additional feature upon later features in the model 108 results in the effect cascading through the feature tree 104 and such that they are shown in the displayed feature model 108. For example, a recess or hole added to the cuboid 110a prior to the boss 110b being added may also pass into the boss 110b once it has been added to the model 108.

As is apparent after a number of features have been added to a primitive block, for example the cuboid 110a, it becomes difficult to distinguish an individual feature from the model 108 and the feature tree 104 is a useful graphical representation that allows a user to view the effects of features upon one another.

The dialogue box 106 is associated with one of the features 112b in the feature tree 104 and allows the manipulation and alteration of the attributes. In the example of the dialogue box 106, a removal of material from the model 108 is executed. There are a number of parameters that can be altered in carrying this out, for example the type of removal, blind, through etc., and the depths of the cut.

Referring now to FIG. 2, a computer generated model 200 of an object comprises a model consisting of a single parametric surface 202 and a faceted model composed of a polygon mesh 204.

The mesh 204 is superposed upon the parametric surface 202 but remains independent of it. Thus, any changes effected to the surface 202 are not directly mirrored in the mesh 204. For example, if the radius of the surface 202 is increased to beyond the mesh 204 the mesh 204 will be subsumed within the surface 202, it will not move outwards in concert with the surface 202. The effect of this is that using current systems it is possible that an embossed feature, modelled as a mesh, may not be accurately reproduced when the object is machined using a control data set based upon the model because of inconsistencies between the surface 202 and the mesh 204.

Referring now to FIG. 3, a computer 300 comprises a processor unit 302, a visual display unit (VDU) 304, a keyboard 306, a mouse 308 and a data storage device 310.

An example of a suitable computer 300 is shown in FIG. 11 and comprises the VDU 304, processor unit 302, a keyboard 306, and mouse 308. The processor unit 302 further comprises a processing unit 1112, a hard drive 1114, a video driver 1116, memory 1118 (RAM and ROM) and an I/O subsystem 1120 which all communicate with one another, as is known in the art, via a system bus 1122. The processing unit 1112 comprises an INTEL PENTIUM series processor, typically running in excess of 1 GHz.

As is known in the art the ROM portion of the memory 1118 contains the Basic Input Output System (BIOS) that controls basic hardware functionality. The RAM portion of memory 1118 is a volatile memory used to hold instructions that are being executed, such as program code, etc. The hard drive 1114 is used as mass storage for programs and other data.

Also as is known in the art, the video driver 1116 comprises a dedicated hardware graphics processor arranged to process data in order to generate a signal suitable for driving the VDU 304. Such a graphics processor, although not essential to the functioning of the computer 300, helps to remove the computationally intensive task of generating the signal to drive the VDU 304 from the processing unit 1112.

Other devices such as CD-ROMs, DVD ROMS, network cards, etc. could be coupled to the system bus 1122 and allow for storage of data, communication with other computers over a network, etc.

The computer 300 could have the architecture known as a PC, originally based on the IBM specification, but could equally have other architectures. The server may be an APPLE, or may be a RISC system, and may run a variety of operating systems (perhaps HP-UX, LINUX, UNIX, MICROSOFT NT, AIX™, or the like).

The processor unit 302 receives user inputs from the keyboard 306 and mouse 308 when a modelling software package is being executed from which a computer model is produced and displayed upon the VDU 304. Surface data relief to be applied to the computer model is stored on the storage device 310. The relief data can be either generated locally or alternatively, generated at a remote computer and transmitted to the computer 300 via a network, or on a disc, etc.

The relief data is displayed upon the VDU 304 as the relief. The relief is manipulated by the user using the keyboard 306 and mouse 308, or any other suitable device, for example a joystick or trackball, so that it is to the desired scale, orientation and location relative to the computer model. The user then selects an ‘Emboss’ option from a menu bar.

A boundary of a projection of the relief onto the Brep is then defined and a section of the Brep surface enclosed by the boundary is removed and the relief is conjoined to the Brep at the boundary. This will be discussed in greater detail hereinafter.

Referring now to FIGS. 4 and 5, embossing the mesh upon the surface or solid model involves taking texture space definitions and transformation properties used to position the image of the mesh upon the model and using them to project nodes of the actual mesh into the parameter spaces of the model's surfaces. These nodes are then offset from their original positions on the model's surfaces along a vector, for example, a surface normal at that point, by a distance derived from the height of that node in the relief

Projection is approximately the inverse of texture mapping, and is accelerated using computer graphics hardware, for example a graphics card.

Two significant parts of texture mapping are texture co-ordinate generation (TCG) and transformation. TCG takes a point on a surface and generates co-ordinates in a texture space, for example a cylinder, where the co-ordinates represent an angle of arc around the cylinder (U), a length along its centre line (V) and a perpendicular distance from the cylinder's centre line (W). UVW defines a unit space with its origin at 0 degrees and the cylinder origin, and its maximum extent at (1, 1) at 360 degrees and the cylinder length. The third dimension (radius/W) has an arbitrary positive range.

The TCG generated unit space is transformed by a 4×4 homogeneous texture transformation matrix. The image of the triangles occupies the resulting transformed unit texture space.

Projection is the inverse of texture mapping. Each node in the mesh of triangles has co-ordinates in the unit texture square given by its (x, y) coordinates relative to the XY extent of the mesh. The co-ordinates of any given point are transformed by an inverse of the texture transformation matrix to give a point in an output space of the TCG. This point in the output space of the TCG is then inverted by the TCG to give an object in the TCG input space. This object is a three-dimensional vector, all points on which generate the same output co-ordinates. All target surfaces are intersected by the vector to give a projected position of the node thereupon.

The intersection of the target surfaces is typically accelerated using computer graphics hardware, for example a graphics card. An image-based interpolation method is used to obtain the approximate parameters of the vector-surface intersection and this is then refined by a progressive subdivision method that takes the approximate intersection as its starting point.

The target surfaces are triangulated. In parameter space a two dimensional rectangular surface is defined by Surface parameters (S, T). Given any pair of (S, T) parameters the three dimensional x,y,z position of any point can be evaluated. The texture space co-ordinates (U, V, W) can be generated for each node in a target triangulation. A set of three images of triangles in texture space is made, in each of which a node colour encodes either a surface identifier or the S or T ordinate. In each image, a target triangles' W ordinate is used to perform hidden surface removal. In a surface identifier image, a node colour encodes a surface identifier. In two other images, a one-dimensional texture map is used to encode the surface parameter values, (S,T). This gives a more accurate result, as the resolution of the texture map is no longer limited to 8 bits per channel of node colours.

Given the UV co-ordinates of a point in the triangle mesh to be projected, the surface identifier of the point can be read and the interpolated S and T values can be read from the three images. Thus the identifier of the intersected surface and the approximate surface parameter co-ordinates of the intersection can be obtained.

The projected point is offset along some vector, such as the surface normal, by a distance derived from its original Z ordinate.

The Z ordinates of outside edges of a projected triangulation are forced to zero before projection, so that they lie in the model's surfaces after projection. These outside points are used to create trim boundaries that are merged with any existing boundaries in the target surfaces.

Referring now to FIG. 6a, an object to be manufactured is modelled using a modelling package as a solid model 602 and a relief to be embossed onto the object is modelled as a planar facet mesh 604

The mesh 604 becomes a feature of the solid model 602. This feature 604 and other pre-existing features of the model 602 can be manipulated independently. Changes to other features (e.g. resizing), which effect the surface on which the relief was embossed will cause the relief to be re-wrapped or re-projected and/or re-trimmed into the solid.

Changes to the relief feature 604 itself, would typically include adding additional detail, smoothing or sculpting (using a voxel, height field or facetted modeller). On exit from the relief editor, the altered mesh 604 would be re-wrapped or re-projected and/or re-trimmed into the solid model 602.

In order to emboss the model 602 with the mesh 604 it is necessary to project the mesh 604 onto the model 602, typically using a texture mapping technique. A texture mapping technique involves using a graphics card of a computer to wrap the mesh 604 on to the model 602 such that the faces of model 602 and the mesh 604 conform to each other.

A boundary 606 defines the edge of the intersection between the model 602 and the mesh 604. A void 608 is made in the model 602 that conforms to the projection of the wrapped mesh 604 on to the model 602 and is enclosed by the boundary 606.

The boundary 606 is defined by an intersection of the model 602 and each triangle in the mesh 604 as discussed in detail herein before.

Referring now to FIG. 6d, the model 602 is converted to a polygonal, usually triangulated, surface 610. Contiguous 612, 614 edges of triangles 616, 618 of the mesh 604 and the surface 610 are constrained to have the same lengths. This results in no gaps in the model of the object thereby making the data set generated watertight. The use of triangular polygons in the model also makes the data set generated suitable for use with rapid prototyping machines. Commonly known rapid prototyping machines include those using stereolithography, selective laser sintering, fused deposition modelling, laminated object modelling and inkjet deposition.

Referring now to FIGS. 7a and 7b a shoe has a blank sole 702. The sole 702 is modelled using a conventional solid modelling package. A tread pattern 704 is modelled, using a conventional relief modelling package, in the form of a polygonal mesh. The tread pattern 704 is projected onto the sole 702, in the appropriate location, and a hole is formed in the model of the sole 702 corresponding to the projection of the tread 704 onto the sole 702. The tread 704 is wrapped into the hole and the edges of the hole and the tread 704 are watertightly joined as described hereinbefore.

Referring now to FIG. 8, a feature tree 800 comprises a list of operations, features, 802 carried out in the construction of a model of an object. The feature tree 800 includes an emboss feature 804 corresponds to the embossing of a relief upon a body of the object in the model. The embossing of the relief upon the body in the model is carried out as hereinbefore described.

After any change to a feature of the model, (for example resizing) the relief is re-wrapped or re-projected and/or re-trimmed onto the model and the effects of the change of the features on the relief are seen in the final model display on the screen.

Referring now to FIG. 9, a machine tool 900 comprises a working area 902, a machine head 904, processing circuitry 906 for controlling the tool 900. The working area 902 typically accommodates a piece of material from which material is removed in machining operations, in the case of a milling machine in which case the machine head 904 is a milling head. The tool 900 may be a rapid prototyping machine in which case the working area 902 and machine head 904 will be appropriate to the type of RPT machine.

The processing circuitry 906 comprises a display 908 arranged to display information, a keyboard 910 for inputting information to the processing circuitry 908 and a date carrier reader 912 arranged to read media for example CD ROMs, magnetic discs. The processing circuitry 906 may be a computer such as a PC or it may be provided as part of the tool 900.

The processing circuitry 906 will typically receive control data for the tool 900 via the reader 912 and will process the control data so as to drive the machine head 904 relative to the work area 902, or vice versa in order to fabricate a desired object.

Referring now to FIG. 10, the generation of a control data set for a machine tool includes generating a parametric surface corresponding to an object to be modelled (step 1000). A mesh corresponding to a relief is also modelled typically using texture mapping-like techniques (step 1002). The mesh is projected onto the surface and a boundary of a footprint of the mesh on the surface is determined (step 1004). The portion of the surface internal of the boundary is deleted (step 1006). The mesh and the relief are coupled at the boundary (step 1008).

1. A method of generating a computer model which provides means for processing data, capable of generating, of processing, of transforming and of storing said data and further comprising the steps of:
(i) causing said processing means to generate a parametric surface indicative of the shape of an object;
(ii) causing said processing means to generate a mesh indicative of the shape of a relief, said mesh having at least one edge and said relief having associated height contours;
(iii) causing said processing means to execute at least one of the following so as to preserve said height contours of said relief relative to one another: projecting said mesh onto said surface; wrapping said mesh onto said surface; and intersecting said mesh with said surface; and
(iv) causing said processing means to determine a trim boundary of said surface; said trim boundary having at least one edge such that said at least one edge of said mesh and said at least one edge of said trim boundary are contiguous, by said execution of said processing means causing at least one of the following; projecting said mesh onto said surface; wrapping said mesh onto said surface; and intersecting said mesh with said surface.

2. A method according to claim 1 which further comprises the steps of causing said processing means to determine a portion of said surface to be overlaid by said mesh and to trim said portion.

3. A method according to claim 1 further comprising causing said processing means to store a record of each execution of at least one of projecting said mesh onto said surface; wrapping said mesh onto said surface; and intersecting said mesh with said surface.

4. A method according to claim 3 further comprising providing a display means capable of displaying data, said display means being arranged to display said record of said executions and allowing a user to select at least one of said executions for alteration thereof.

5. A method according to claim 1 which comprises combining said surface and said mesh such that a change executed to said surface causes said processing means to re-calculate said mesh such that said at least one edge of said mesh and said trim boundary remain contiguous.

6. A method according to claim 1 further comprising varying at least one of the following between said mesh and said surface: the position; the orientation.

7. A method according to claim 1 in which said computer model is arranged to provide data to control a machine tool.

8. A method according to claim 1 comprising dividing said mesh into polygonal facets, generating a set of images of said polygonal facets, each image comprising a plurality of pixels, wherein each of said pixels has a value assigned thereto representing a surface parameter of a point on said surface to where said pixel will be one of wrapped and projected.

9. A method according to claim 1 wherein the method includes at least one of projecting, intersecting and wrapping said mesh onto said surface in a common co-ordinate system.

10. A method according to claim 9 including calculating an approximate point of coincidence between a node of said mesh and a point on said surface.

11. A method according to claim 10 wherein said calculation of said approximate point of coincidence includes zoning said surface into polygons.

12. A method according to claim 11 wherein said zoning said surface into polygons includes interpolating the location of a node of said mesh within a given said polygon using co-ordinates that are usually associated with surface parameters that define the surface.

13. A method according to claim 12 wherein said co-ordinates correspond to the vertices of said polygon.

14. A method according to claim 1 comprising generating polygons on said surface.

15. A method according to claim 14 comprising matching contiguous edges of respective polygons of said surface and said mesh.

16. A method according to claim 1 including providing a library of reliefs from each of which said mesh can be generated.

17. A system for generating a computer model, said system comprising a parametric surface generator capable of generating a surface and arranged to generate a parametric surface, a mesh generator capable of generating a mesh and arranged to generate a mesh representing a relief, a boundary generating means capable of generating a boundary and arranged to generate a boundary at least a portion of which is arranged to lie within said parametric surface generated by said parametric surface generator, and a projector means, for projecting said mesh and arranged to project said mesh onto said boundary.

18. A system according to claim 17 which further comprises a trimming means capable of trimming a surface and arranged to trim away a portion of said parametric surface defined by said boundary.

19. A system according to claim 17 which further comprises a coupling means, capable of coupling a surface and a mesh, arranged to couple said parametric surface and said mesh.

20. A machine tool, capable of receiving commands from a processor and of machining an article, said machine tool being arranged to produce a workpiece, said workpiece comprising a surface relief, in response to commands received from said processor, said commands being generated in response to a computer model of said workpiece, said model being generated in accordance with claim 1.

21. A method of controlling a machine tool, said machine tool being capable of being driven according to a set of commands and comprising a tool head capable of motion, said method comprising the steps of:
(i) providing a data generating means capable of generating and of transmitting data and arranged to generate a control data set representative of a computer model of a workpiece, said computer model comprising a surface relief, and being generated in accordance with claim 1;
(ii) providing a command generating means capable of receiving data from said data generating means and of using said data to generate commands, said command generating means being arranged to generate a set of commands to drive said machine tool;
(iii) imparting relative motion between said tool head of said machine tool and a substance arranged to form said workpiece.

22. Processing circuitry arranged to generate a computer model of a workpiece in accordance with claim 1.

23. A method of generating a computer model which provides means for processing data, capable of generating, of processing, of transforming and of storing said data and further comprising the steps of:
(i) causing said processing means to generate a parametric surface indicative of the shape of an object;
(ii) causing said processing means to generate a mesh indicative of the shape of a relief, said mesh having an outside contour and said relief having associated height contours;
(iii) causing said processing means to generate a plurality of polygons approximating to said mesh;
(iv) causing said processing means to generate a plurality of polygons approximating to said parametric surface;
(v) causing said processing means to execute at least one of the following so as to preserve said height contours of said relief relative to one another: projecting said mesh onto said surface; wrapping said mesh onto said surface; and intersecting said mesh with said surface;
(vi) causing said processing means to determine a trim boundary of said surface, said trim boundary bounding a void within said surface, such that said outside contour of said mesh and said trim boundary are contiguous, by said execution of said processing means causing at least one of the following: projecting said mesh onto said surface; wrapping said mesh onto said surface; and intersecting said mesh with said surface; and
(vii) causing said processing means to ensure that said polygons approximating to said mesh and said polygons approximating to said parametric surface including matching contiguous edges.

24. A computer readable memory device arranged to be encoded with a data structure for producing a computer model comprising a first entry and a second entry, said first entry comprising a parameter relating to a trim boundary of a parametric surface, said second entry comprising a parameter relating to an outer edge of a polygonal mesh; said first and second entries having substantially the same values.

25. A machine readable medium capable of storing data and readable by a machine and arranged to store a program of instructions which when operated on said machine causes said machine to execute said method of claim 1.

26. A machine readable medium capable of storing data and readable by a machine and arranged to store a program of instructions which when operated on said machine causes said machine to execute said method of claim 12.

27. A machine readable medium capable of storing data and readable by a machine and arranged to store a program of instructions which when operated on said machine causes said machine to execute said method of claim 14.

28. A machine readable medium capable of storing data and readable by a machine and arranged to store a program of instructions which when operated on said machine causes said machine to operate as a machine tool in accordance with claim 8.

29. An object machined using a control data set generated from a model produced in accordance with the method of claim 1.
